(19) United States
(12) Patent Application Publication
(10) Pub. No.: US 2005/0204870 A1
(43) Pub. Date: Sep. 22, 2005

(54) Disc strap wrench

(76) Inventor: Kang Hsin Fa, Tainan City (TW)

Correspondence Address: Kang Hsin Fa, P.O. Box 90, Tainan City, 704, TW

(21) Appl. No.: 10/805,568

(22) Filed: Mar. 18, 2004

(51) Int. Cl. B25B 13/52

(52) U.S. Cl. 81/64

(57) ABSTRACT

A disc strap wrench includes a tubular member, a flexible leather strap and a metal fixing block. The tubular member has a first end provided with a grip, and a second end provided with a stop member. The leather strap extends through the whole length of the tubular member, having an outer end fixed firmly in the metal fixing block, and an inner end protruding out of the first end of the tubular member, and a plurality of linear grooves on its inner side. The metal fixing block sandwiches the outer end of the strap in a center hole, and fixed in the second end of the tubular member. Then the disc strap wrench is usable for securing the disc in an automobile for taking off and assembling components on the disc, convenient to use.

### BACKGROUND OF THE INVENTION

1. Field of the Invention

This invention relates to a disc strap wrench, particularly to one provided with a flexible leather strap having its inner surface formed with a plurality of linear grooves, a metal fixing block for fixing the outer end of the strap in a lengthwise center hole. The metal fixing block has a plurality of linear grooves formed in the wall defining the center hole to engage with the linear grooves of the leather strap, and then the outer end of the leather strap is secured in the center hole by compressing the outer walls of the metal fixing block. Further, the metal fixing block is secured in the second end of the tubular member by screws sidewise screwing in the tubular member and the metal fixing block. Then the disc strap wrench can be used for securing the disc of an automobile for taking off or assembling components on the disc.

2. Description of the Prior Art

In taking off a rotatable disc A1 of an vehicle, as shown in FIG. 1, a socket wrench A2 is used for loosening a bolt A3, but the bolt A3 is very hard to be loosened owing to the disc always rotating. So a conventional disc strap wrench 1 provided with a strap 11 is used, as shown in FIGS. 1,2 and 3, fixing immovable the rotating disc A1 and then the bolt A3 can be loosened off. The disc strap wrench 1 has a tubular member 10 of a rectangular cross-section, a grip 100 formed at a first end of the tubular member 10, a stop member 101 fixed at a second end, and screw holes 102 bored in the wall opposite to the stop member 101. Further, the strap 11 extends through the tubular member 10, having an outer end protruding out of the second end of the tubular member 10 and an inner end protruding out of the second end of the tubular member 10. Further, two fixing blocks 12 are in advance glued to the outer end of the strap 11, sandwiching the outer end of the strap 11 and then screwed with the tubular member 10. The fixing blocks 12 further have respectively a curved-down pinching surface 120 formed in an inner side, and two threaded holes 121 aligned to the threaded holes 102 of the tubular member 10 and the holes 110 of the strap 11 for screws 13 to screw them tightly together.

In using the conventional disc strap wrench 1, as shown in FIG. 1, the outer end of the strap 11 is bent to fit around the disc A1, and then the inner end of the strap 11 is pulled out, forcing the outer end tightly pinching the disc 11, with the stop member 101 tightly pushing against the disc 11. Thus, a user can take off the bolt A3 by rotating the socket wrench A2, with the disc A1 kept immovable by the disc strap wrench 1. The conventional disc strap wrench 1 makes use of the two fixing blocks 12 for pinching the outer end of the strap 11 and then tightly screwed with the tubular member 10. As the fixing blocks 12 have the curved-down surface 120 facing the outer end of the strap 11 for gluing together, as shown in FIG. 3, and then after the glue hardened the fixing block can be combined with the tubular member 10, assembly of the conventional disc strap wrench is very troublesome and time-taking. Moreover, the fixing blocks are not easily aligned with the holes, very unfavorable for manufacture and alignment.

### SUMMARY OF THE INVENTION

The objective of the invention is to offer a disc strap wrench having a metal fixing block provided with a lengthwise center hole, and an inner wall of the center hole provided with a plurality of lengthwise parallel grooves to engage with a plurality of lengthwise parallel grooves provided on an inner lengthwise wall of a leather strap. The outer end of the leather strap is fixed stably in the center hole of the metal fixing block so that the flexible leather strap can be adjusted to tightly hold tightly the disc in an automobile for taking off components on the disc.

The feature of the invention is a fixing block provided with a lengthwise center hole, and a plurality of lengthwise linear grooves formed in an inner wall defining the center hole, and a plurality of threaded holes formed in a vertical outer side and aligned with the threaded holes provided in a tubular member. Then after the outer end of the leather strap is inserted in the center hole, the metal fixing block is compressed to force the walls of the center hole to sandwich the outer end of the leather strap tightly to secure the leather strap with the metal fixing block.

### BRIEF DESCRIPTION OF DRAWINGS

This invention will be better understood by referring to the accompanying drawings, wherein:

FIG. 1 is a perspective view of a conventional disc strap wrench being used for loosening a bolt of a disc;

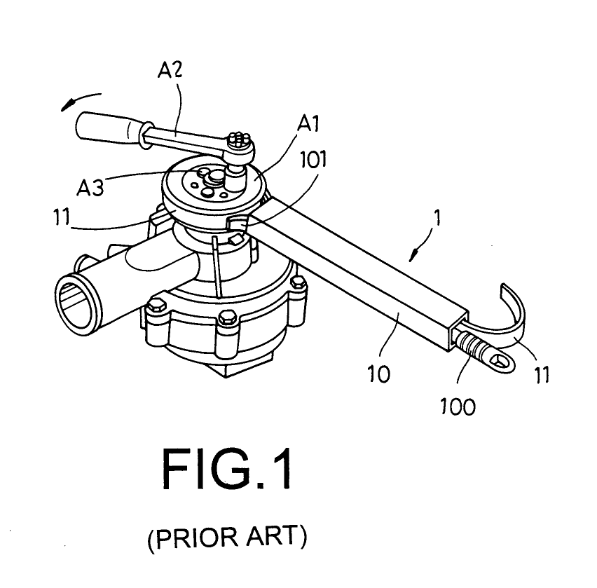

FIG. 2 is an exploded perspective view of the conventional disc strap wrench;

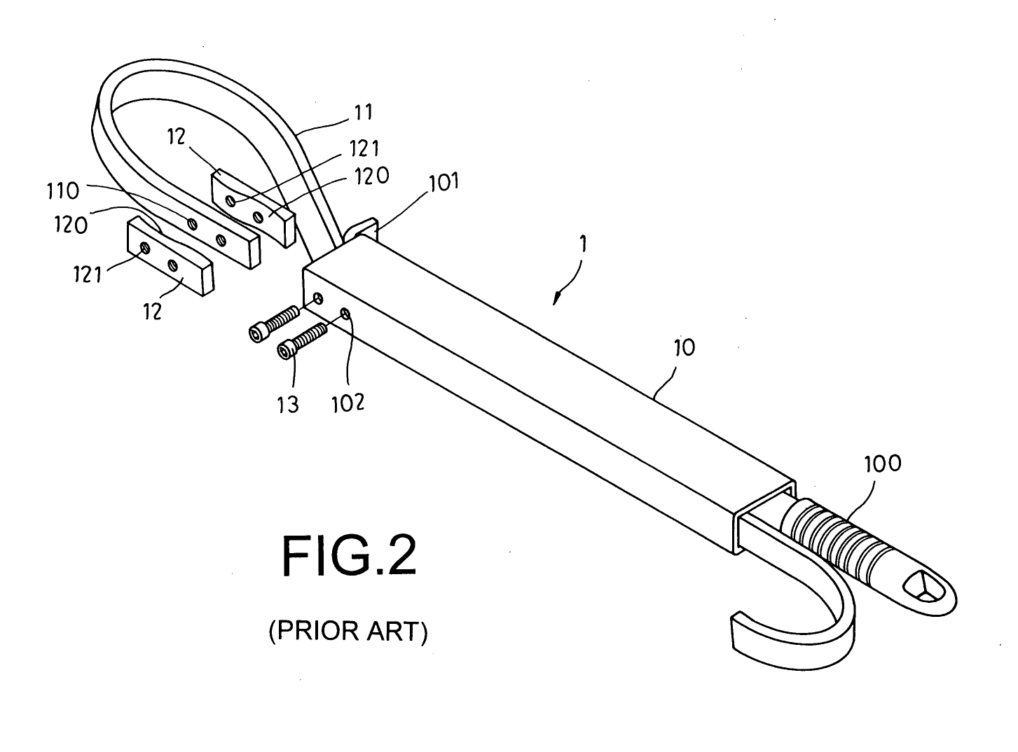

FIG. 3 is a perspective view of the conventional disc strap wrench, with fixing members glued to a strap before assembling the disc strap wrench;

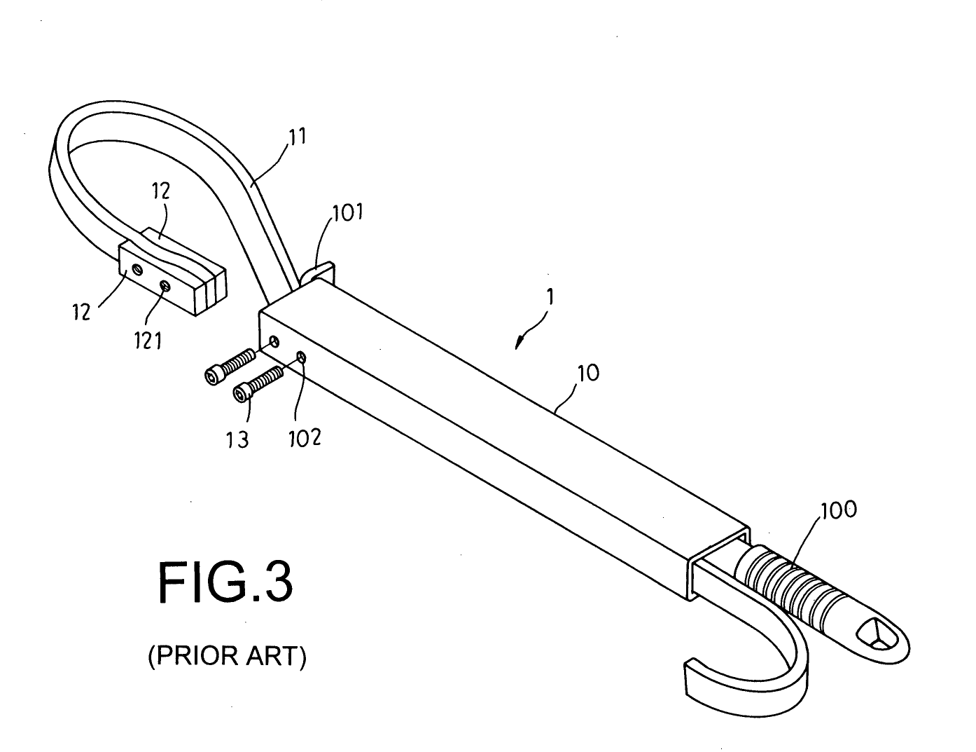

FIG. 4 is an exploded perspective view of a disc strap wrench in the present invention; and,

FIG. 5 is a cross-sectional view of the disc strap wrench in the present invention.

### DETAILED DESCRIPTION OF THE PREFERRED EMBODIMENT

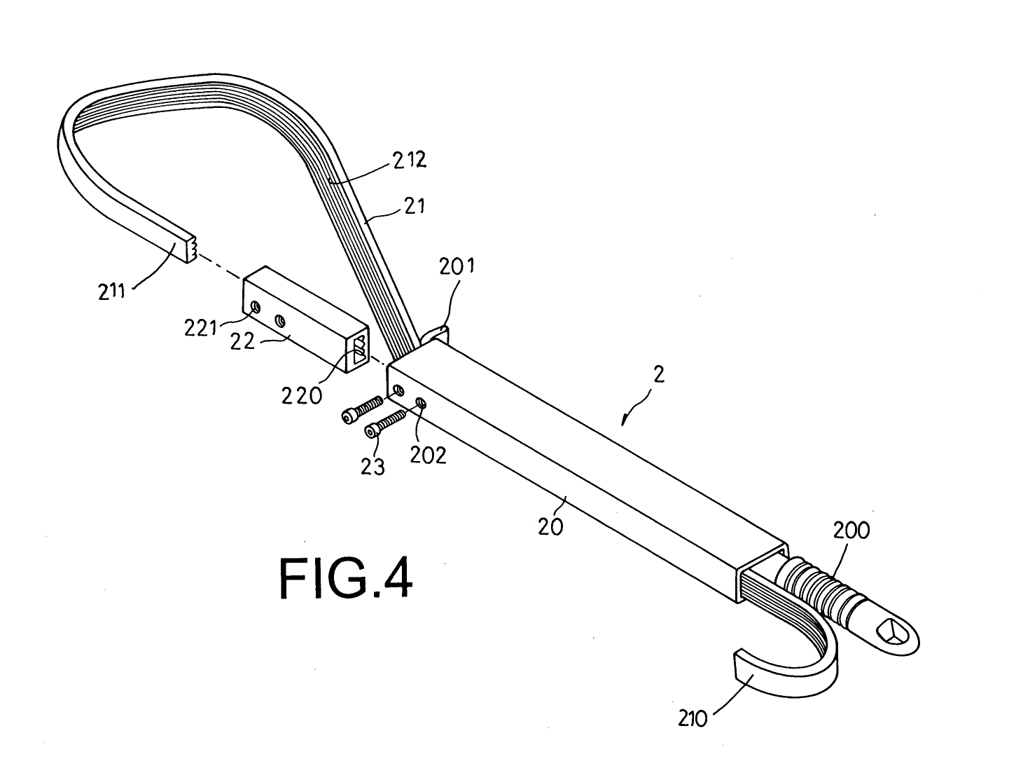

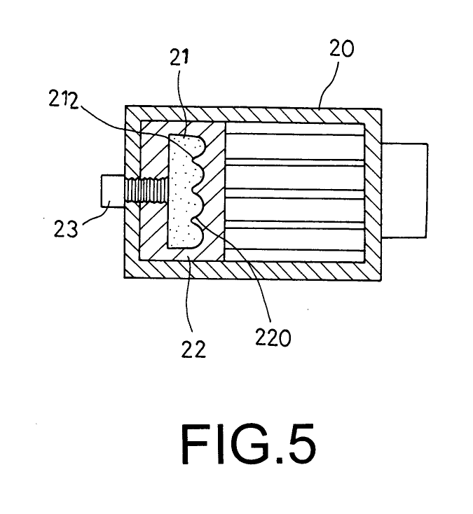

A first embodiment of a disc strap wrench in the present invention, as shown FIGS. 4, 5, includes a tubular member 20 of a rectangular cross-section, a flexible leather strap 21, and a metal fixing block 22 as main components combined together.

The tubular member 20 is elongate, having a grip 200 connected with and extending out of its first end, a stop member 201 fixed at its second end, and a plurality of threaded holes 202 in a vertical side of its front-end for screws 23 to screw therein.

The flexible leather strap 21 extends through the whole length of the tubular member 20, having its front end 210 protruding out of the first end of the tubular member 20 beside the grip 200 and its rear (free) end 211 protruding out of the second end of the tubular member 20. Further, the strap 21 has a plurality of lengthwise linear grooves 212 formed parallel in an inner side.

The metal fixing block 22 is to fix firmly the outer (front) end 211 of the strap 21, having a lengthwise hole and lengthwise linear grooves 220 formed in an inner wall of the lengthwise hole to engage with the linear grooves 212 of the leather strap 21. The metal fixing block 22 further has a plurality of sidewise threaded holes 221 for screws 23 to screw therein to secure the outer end 211 of the leather strap 21 in the metal fixing block 22.

In assembling, the outer end 211 of the leather strap 21 is fixed in the metal fixing block 22, letting the linear grooves 212 fitting with the linear grooves 220 of the metal fixing block 22. Then the metal fixing block 22 is compressed to force the walls of the center hole tightly push against the leather strap 21 to fix the outer end 211 of the leather strip 21 tightly in the metal fixing block 22. Lastly, the threaded holes 221 of the metal fixing block 22 are aligned to the threaded holes 202 of the tubular member 20 for the screws 23 to engage therein to secure the metal fixing block 22 with the tubular member 20, finishing assemblage of the disc strap wrench. Thus, the disc strap wrench can be used to catch hold of the disc of an automobile for taking off the components of the disc.

While the preferred embodiment of the invention has been described above, it will be recognized and understood that various modifications may be made therein and the appended claims are intended to cover all such modifications that may fall within the spirit and scope of the invention.

1. A disc strap wrench comprising a tubular member of a rectangular cross-section having a grip connected with and extending out of its first end, and a stop member fixed at a second end of said tubular member, and a plurality of threaded holes formed in a vertical side opposite to said stop member, and a flexible leather strap extending in the whole length of said tubular member and having its front end protruding out of a first end of said tubular member, said leather strap having its rear end protruding out of a second end of said tubular member; and,
characterized by a metal fixing block fixing firmly said outer end of said leather strap and having a lengthwise center hole, said center hole having its inner wall provided a plurality of linear parallel grooves, said metal fixing block having a plurality of threaded holes in a vertical outer side, said threaded holes aligned to said threaded holes of said tubular member for screws to screw therein; said outer end of said leather strap secured tightly in said metal fixing block by compressing the metal fixing block so as to secure said leather strap with said metal fixing block, said metal fixing block then secured tightly with said tubular member by screws screwing in said threaded holes of both tubular member and said metal fixing block, said disc strap wrench usable for securing the disc of an automobile so as to take off and assemble components on the disc.

2. The disc strap wrench as claimed in claim 1, wherein said flexible leather strap has a plurality of wave-like linear grooves in an inner surface.

3. A disc strap wrench as claimed in claim 1, wherein said metal fixing block has a plurality of wave-like linear grooves in the wall defining said center hole.
